(19) United States
(12) Patent Application Publication
(10) Pub. No.: US 2026/0046782 A1
(43) Pub. Date: Feb. 12, 2026

(54) UPLINK POWER CONTROL METHOD, DEVICE, AND STORAGE MEDIUM

(71) Applicant: Beijing Xiaomi Mobile Software Co., Ltd., Beijing (CN)

(72) Inventor: Xueyuan GAO, Beijing (CN)

(73) Assignee: Beijing Xiaomi Mobile Software Co., Ltd., Beijing (CN)

(21) Appl. No.: 18/998,400

(22) PCT Filed: Jul. 27, 2022
(86) PCT No.: PCT/CN2022/108119

§ 371 Date: Jan. 24, 2025

(51) Int. Cl. H04W 52/14; H04W 72/232

(52) U.S. Cl. CPC H04W 52/146; H04W 72/232

(57) ABSTRACT

An uplink power control method includes: receiving, by a terminal device, configuration information of a maximum transmitting power sent by an access network device, the configuration information of the maximum transmitting power being configured to determine respective panel maximum transmitting powers P_{CMAX,P} corresponding to uplink transmissions respectively performed by the terminal device via two antenna panels in a case of scheduling STxMP by M-DCI. The terminal device includes a plurality of antenna panels and supports simultaneous uplink transmissions via the plurality of antenna panels.

### CROSS-REFERENCE TO RELATED APPLICATIONS

The present application is a U.S. National Stage of International Application No. PCT/CN2022/108119 filed on Jul. 27, 2022, the entire contents of which are incorporated herein by reference for all purposes.

### TECHNICAL FIELD

The present disclosure relates to the field of wireless communication, and in particular, to an uplink power control method, device, apparatus and storage medium.

### BACKGROUND

In 3GPP (3rd Generation Partnership Project) R18 (Release 18) uplink (Multiple Input Multiple Output) enhancement, it considers realizing, via a plurality of panels (antenna panels) of a terminal device, simultaneous uplink transmissions towards a plurality of TRPs (transmit/receive point), so as to further improve transmission reliability and throughput rate and of uplink transmission.

In the related art, a terminal device determines a transmitting power for the uplink transmission based on a maximum transmitting power configured by the network side.

When scheduling simultaneous transmission via multi-panel based on M-DCI (multi-downlink control information), how to control uplink power is an urgent problem to be solved.

### SUMMARY

Embodiments of the present disclosure provide an uplink power control method, device, apparatus, and storage medium.

An aspect of the present disclosure provides an uplink power control method, performed by a terminal device, including:
receiving configuration information of a maximum transmitting power sent by an access network device, the configuration information of the maximum transmitting power being configured to determine respective panel maximum transmitting powers P_{CMAX,P} corresponding to uplink transmissions respectively performed by the terminal device via two antenna panels in a case of scheduling simultaneous transmission via multi-panel (STxMP) by multi-downlink control information (M-DCI),
wherein the terminal device includes a plurality of antenna panels and supports simultaneous uplink transmissions via the plurality of antenna panels.

An aspect of the present disclosure provides an uplink power control method, performed by an access network device, including:
sending configuration information of a maximum transmitting power to a terminal device, the configuration information of the maximum transmitting power being configured to determine respective panel maximum transmitting powers P_{CMAX,P} corresponding to uplink transmissions respectively performed by the terminal device via two antenna panels in a case of scheduling simultaneous transmission via multi-panel (STxMP) by multi-downlink control information (M-DCI),
wherein the terminal device includes a plurality of antenna panels and supports simultaneous uplink transmissions via the plurality of antenna panels.

An aspect of the present disclosure provides an uplink power control device, including:
a receiving module, configured to receive configuration information of a maximum transmitting power sent by an access network device, the configuration information of the maximum transmitting power being configured to determine respective panel maximum transmitting powers P_{CMAX,P} corresponding to uplink transmissions respectively performed by the terminal device via two antenna panels in a case of scheduling simultaneous transmission via multi-panel (STxMP) by multi-downlink control information (M-DCI),
wherein the terminal device includes a plurality of antenna panels and supports simultaneous uplink transmissions via the plurality of antenna panels.

An aspect of the present disclosure provides an uplink power control device, includes:
a sending module, configured to send configuration information of a maximum transmitting power to a terminal device, the configuration information of the maximum transmitting power being configured to determine respective panel maximum transmitting powers P_{CMAX,P} corresponding to uplink transmissions respectively performed by the terminal device via two antenna panels in a case of scheduling simultaneous transmission via multi-panel (STxMP) by multi-downlink control information (M-DCI),
wherein the terminal device includes a plurality of antenna panels and supports simultaneous uplink transmissions via the plurality of antenna panels.

An aspect of the present disclosure provides a terminal device, including a processor and a transceiver connected to the processor,
wherein the transceiver is configured to receive configuration information of a maximum transmitting power sent by an access network device, the configuration information of the maximum transmitting power being configured to determine respective panel maximum transmitting powers P_{CMAX,P} corresponding to uplink transmissions respectively performed by the terminal device via two antenna panels in a case of scheduling simultaneous transmission via multi-panel (STxMP) by multi-downlink control information (M-DCI),
wherein the terminal device includes a plurality of antenna panels and supports simultaneous uplink transmissions via the plurality of antenna panels.

An aspect of the present disclosure provides a network device, including a processor and a transceiver connected to the processor,
wherein the transceiver is configured to send configuration information of a maximum transmitting power to a terminal device, the configuration information of the maximum transmitting power being configured to determine respective panel maximum transmitting powers P_{CMAX,P} corresponding to uplink transmissions respectively performed by the terminal device via two antenna panels in a case of scheduling simultaneous transmission via multi-panel (STxMP) by multi-downlink control information (M-DCI),
wherein the terminal device includes a plurality of antenna panels and supports simultaneous uplink transmissions via the plurality of antenna panels.

An aspect of the present disclosure provides a computer-readable storage medium having executable instructions stored thereon, and the executable instructions are loaded and executed by a processor to implement the uplink power control method according to the above aspect.

An aspect of the present disclosure provides a chip including a programmable logic circuit or program, and the chip is configured to implement the uplink power control method according to the above aspect when running on a computer device.

An aspect of the present disclosure provides a computer program product that, when running on a processor of a computer device, causes the computer device to execute the uplink power control method according to the above aspect when running on a computer device.

### BRIEF DESCRIPTION OF THE DRAWINGS

In order to more clearly illustrate the technical solution in the embodiments of the present disclosure, the accompanying drawings used in the description of the embodiments will be briefly described below. Obviously, the accompanying drawings in the following description are only some of the embodiments of the present disclosure, and a person skilled in the art may obtain other accompanying drawings on the basis of these drawings without creative labor.

FIG. 1 is a schematic diagram of a system architecture provided by an embodiment of the present disclosure;

FIG. 2 is a schematic diagram of single DCI scheduling provided by an embodiment of the present disclosure;

FIG. 3 is a schematic diagram of multi-DCI scheduling provided by an embodiment of the present disclosure;

FIG. 4 is a flowchart of an uplink power control method provided by an embodiment of the present disclosure;

FIG. 5 is a flowchart of an uplink power control method provided by an embodiment of the present disclosure;

FIG. 6 is a flowchart of an uplink power control method provided by an embodiment of the present disclosure;

FIG. 7 is a schematic diagram of a first transmission occasion and a second transmission occasion provided by an embodiment of the present disclosure;

FIG. 8 is a structural block diagram of an uplink power control device provided by an embodiment of the present disclosure;

FIG. 9 is a structural block diagram of an uplink power control device provided by an embodiment of the present disclosure; and

FIG. 10 is a schematic structure diagram of a communication device provided by an embodiment of the present disclosure.

### DETAILED DESCRIPTION

In order to make the object, technical solution and advantage of the present disclosure clearer, the implementations of the present disclosure will be described in further detail below in connection with the accompanying drawings.

Embodiments will be described herein in detail, examples of which are shown in the accompanying drawings. When the following description relates to the accompanying drawings, the same reference numerals in different accompanying drawings indicate the same or similar elements unless indicated otherwise. The implementations described in the following embodiments do not represent all the implementations consistent with the present disclosure. Rather, they are only examples of devices and methods consistent with some aspects of the present disclosure as detailed in the appended claims.

The terms used in the present disclosure are used solely for describing particular embodiments and are not intended to limit the present disclosure. The singular forms of “a”, “an”, “said”, and “the” used in the present disclosure and the appended claims are also intended to include a plural form unless indicated otherwise. It is to be also understood that the term “and/or” as used herein refers to and include any or all possible combinations of one or more of the associated listed items.

It is to be understood that although the terms first, second, third, etc. may be used in the present disclosure to describe various information, such information should not be limited by these terms. These terms are used only to distinguish the same type of information from one another. For example, without departing from the scope of the present disclosure, first information may be referred to as second information, and similarly, second information may also be referred to as first information. Depending on the context, for example, the word “if” as used herein may be interpreted as “at the time of . . . ” or “when . . . ” or “in response to determining”.

Referring to FIG. 1, the technical solution provided by the embodiments of the present disclosure is applied in a communication system including a network device 11 and a terminal device 10.

The network device 11 is a device that provides a wireless communication function for the terminal. For example, the network device may also be referred to as an access network device. The network device 11 includes, but is not limited to: gNB in 5G, radio network controller (RNC), node B (NB), base station controller (BSC), base transceiver station (BTS), home base station (e.g., home evolved node B, or home node B (HNB)), base band unit (BBU), transmission-reception point (TRP, transmitting and receiving point), transmitting point (TP), mobile switching center or the like. The network device in the present disclosure may also be a device providing wireless communication function for the terminal in other communication systems that may emerge in the future. As the communication technology develops, the name “network device” may change. For convenience of description, in the embodiments of the present disclosure, the above-mentioned devices providing the wireless communication function for the terminal device 10 are collectively referred to as network devices.

The TRP in the embodiments of the present disclosure may refer to any component (or collection of components) used to provide wireless access to a network, such as macro cell, femtocell, Wi-Fi access point (AP), or other device that supports wireless communication. The TRP may provide wireless access according to one or more wireless communication protocols, such as 5th generation new radio (5G NR), long term evolution (LTE), LTE advanced (LTE-A), high speed packet access (HSPA), wi-fi 802.11a/b/g/n/ac/ac or the like.

For example, one access network device is deployed with one or more TRPs, e.g., the access network device corresponds to a first TRP and a second TRP. Alternatively, a first access network device corresponds to a first TRP, and a second access network device corresponds to a second TRP.

The terminal device 10 is a device that can provide voice and/or data connectivity to a user. For example, the terminal device includes a handheld device and a vehicle-mounted device with a wireless communication function, or the like. Currently, the terminal device may be a mobile phone, a tablet computer, a laptop computer, a PDA, a mobile internet device (MID), a wearable device, a virtual reality (VR) device, an augmented reality (AR) device, a wireless terminal in industrial control, a wireless terminal in self-driving, a wireless terminal in smart grid, a wireless terminal in transport safety, a wireless terminal in smart city, or a wireless terminal in smart home, an in-vehicle device, a computing device or other processing devices connected to wireless modems, and various forms of user equipment (UE), mobile station (MS), or the like.

It is to be noted that the above system architecture is only an illustrative example of the applicable system architecture of the embodiments of the present disclosure, and with comparison with the system architecture shown in FIG. 1, the applicable system architecture of the embodiments of the present disclosure may be provided with more or reduced entities.

In an embodiment, the terminal device has a plurality of panels, and supports simultaneous transmission via the plurality of panels. The plurality of panels may simultaneously perform uplink transmissions or downlink transmissions. For example, the terminal device has two panels, and the two panels send uplink channels/uplink signals to two TRPs, respectively. In general, the plurality of panels are oriented significantly differently, so the uplink PUSCH transmissions via the plurality of panels correspond to different quasi co-locations (QCL), i.e., SpatialRelationInfo.

For example, the network device 11 is deployed with one or more TRPs, e.g., the network device 11 correspondingly has TRP1 and TRP2. The terminal device sends beams in different directions using different panels, and the terminal device repeatedly transmits uplink channel using different transmitting beams that orient to different TRPs. The network device 11 receives, via the plurality of TRPs, the uplink channel repeatedly transmitted by the terminal device. For example, due to different relative orientations of different TRPs to the terminal device, the terminal device uses transmitting beams with different beam directions to send beams to the TRPs in the corresponding directions so as to repeatedly transmit the uplink channel.

The technical solution of the embodiments of the present disclosure may be applied to various communication systems, such as global system of mobile communication (GSM) system, code division multiple access (CDMA) system, wideband code division multiple access (WCDMA) system, general packet radio service (GPRS), long term evolution (LTE) system, LTE frequency division duplex (FDD) system, LTE time division duplex (TDD) system, advanced long term evolution (LTE-A) system, new radio (NR) system, evolved system of NR system, LTE-based access to unlicensed spectrum (LTE-U) system, NR-U system, universal mobile telecommunication system (UMTS), worldwide interoperability for microwave access (WIMA) communication system, wireless local area networks (WLAN), wireless fidelity (WiFi), next-generation communication system, or other communication systems.

In the R17, it standardizes the transmission of PUSCH (physical uplink shared channel) by the terminal device towards TRP directions of a plurality of base stations, which mainly standardizes the collaborative transmission under the TDM (time division multiplexing) transmission manner, so that the terminal device may send, via different transmission occasions (TO) in the time domain, different repetitions of the same information on the PUSCH to different TRPs of the base station in a time division manner. This method has lower requirements on the capability of the terminal device, which does not require the terminal device to support the capability of sending beams simultaneously, and thus has a higher transmission delay.

For uplink transmission, spatial characteristics of actual channels of the PUSCH channels oriented to different TRPs may differ significantly, and therefore the QCL-D (Quasi-Colocation Type D) of the PUSCHs in different transmitting directions is considered to be different.

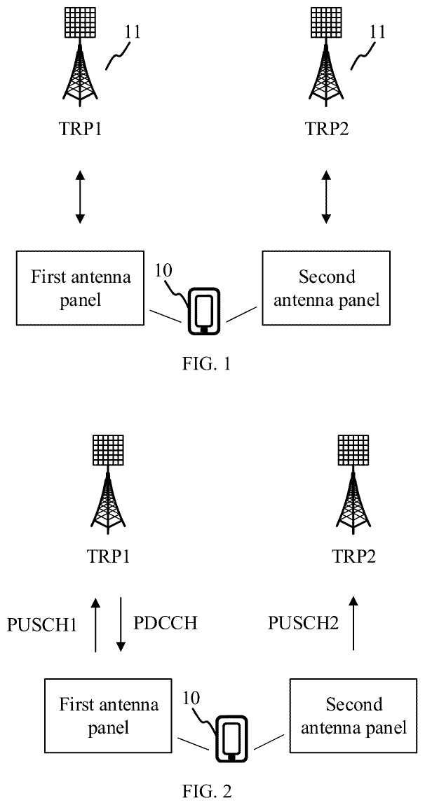

In the R18, it is desired to achieve simultaneous collaborative transmission to TRP directions of a plurality of base stations via a plurality of antenna panels (panels) of a terminal device, so as to increase reliability and throughput of the transmission, and at the same time, to effectively reduce the transmission delay in case of the plurality of TRPs. However such solution requires that the terminal device has the capability of sending a plurality of beams at the same time. The PUSCH transmission may be a multi-panel/TRP transmission scheduled based on a single PDCCH (physical downlink control channel), i.e., a multi-panel/TRP transmission based on S-DCI (single DCI) scheduling. For example, as shown in FIG. 2, a terminal device 10 receives PDCCH 1 sent by TRP 1, the PDCCH 1 carries DCI 1, and the DCI 1 includes scheduling information for PUSCH 1 and PUSCH 2. The terminal device sends the PUSCH 1 to the TRP 1 via a panel 1 based on the DCI 1, and sends the PUSCH 2 to the TRP 2 via a panel 2 based on the DCI 1. The PUSCH transmission may also be a multi-panel/TRP transmission scheduled based on different PDCCHs, i.e. M-DCI (multi DCI). For example, as shown in FIG. 3, a terminal device 10 receives PDCCH 1 sent by TRP 1 and receives PDCCH 2 sent by TRP2. The PDCCH 1 carries DCI 1, and the DCI 1 includes scheduling information of PUSCH 1. The PDCCH 2 carries DCI 2, and the DCI 2 includes scheduling information of PUSCH 2. The terminal device sends the PUSCH 1 to the TRP 1 via panel 1 based on the DCI 1 and sends the PUSCH 2 to the TRP 2 via panel 2 based on the DCI 2.

In a practical deployment, a link between a panel and a TRP may be a relatively ideal backhaul link supporting high throughput and very low backhaul latency, or may be a non-ideal backhaul link using xDSL (x digital subscriber line), microwave, relay or the like. The M-DCI-based NC-JT (non-coherent joint transmission) transmission solution was originally introduced primarily for the non-ideal backhaul situation, but can also be used for the ideal backhaul situation.

In the R18, for uplink MIMO (multiple input multiple output) enhancement, it considers realizing simultaneous uplink transmission to a plurality of TRPs via a plurality of panels of a terminal device, so as to further improve system transmission throughput and transmission reliability in the uplink.

In PDSCH (physical downlink shared channel) based on M-DCI scheduling, different PDSCHs support fully/partially/non-overlapping time-frequency resource allocation. For PUSCH based on DCI scheduling, a similar resource allocation may be considered to be applied. In the R16, the M-DCI PUSCH transmission solution mainly supports the collaborative transmission in TDM (time division multiplexing) manner. Currently, it is necessary to discuss which resource allocation situations are supported and how they should be support in the premise of a plurality of panels.

In a case of different PUSCH time domain resource allocations, as shown in formula I, the current PUSCH power control is mainly performed for transmission occasion. In order to support overlapping resource allocation, a relevant enhancement solution may be considered. Formula I:

$${P}_{P U SCH , p , f , c} ( i , j , {q}_{d} , l ) = min \{ \begin{matrix}{P}_{CMAX , f , c} ( i ) ; \\ {P}_{{O \_}_{PUSCH ,} b , f , c} ( j ) + 10 {log}_{10} ( {2}^{μ} \cdot {M}_{RB , b , f , c}^{PUSCH} ( i ) ) + {α}_{b , f , c} ( j ) \cdot {PL}_{b , f , c} ( {q}_{d} ) + {Δ}_{TF , b , f , c} ( i ) + {f}_{b , f , c} ( i , l )\end{matrix}$$

where P_{PUSCH,p,f,c}(i, j, q_{d}, l) is a transmitting power of a terminal device for transmitting PUSCH at an i^{th} transmission occasion; P_{CMAX,f,c}(i) is a maximum transmitting power on a carrier f of a service cell c determined by a terminal power class and configured by high-level signaling; P_{O}_{_{_PUSCH}}_{,b,f,c}(j) is a target value of PUSCH power, which is given by a parameter configured by high-level signaling, a base station may configure a plurality of parameter sets for the terminal device, and j is an index of the parameter set; P_{O}_{_{_PUSCH}}_{,p,f,c}(j)=P_{O}_{_{_NOMINAL_PUSCH}}_{,b,f}(j)+P_{O_UE}_{_{_PUSCH}}_{,b,f,c}(j), P_{O}_{_{_NOMINAL_PUSCH}}_{,b,f}(j) is a desired received power of PUSCH at a cell level, and P_{O_UE}_{_{_PUSCH}}_{,b,f,c}(j) is a power deviation of PUSCH at a UE level in dynamic scheduling; u is a NR parameter set, which relates to a subcarrier spacing;

$${M}_{RB , b . f . c}^{P U S C H} ( i )$$

is the number of KBs (resource block) occupied by the terminal device to send PUSCH in the i^{th} PUSCH transmission occasion; α_{b,f,c}(j) is a path loss compensation factor, and j is an index of the parameter set; PL_{b,f,c}(q_{d}) is a path loss measured by the terminal device, and q_{d} is an index of a reference signal used to measure the path loss; Δ_{TF,b,f,c}(i) denotes a power offset determined by an MCS (modulation and coding solution) class; and f_{b,f,c}(i, l) is a closed-loop power control adjusted value, and l is an index of closed-loop power control state, which is obtained by TPC (transmit power control) information mapping in PDCCH.

That is, the transmitting power of the terminal device for transmitting PUSCH is the transmitting power minimum value between the maximum

$${P}_{C M A X , f , c} ( i ) and {P}_{{O \_}_{PUSCH ,} b , f , c} ( j ) + 10 {log}_{10} ( {2}^{μ} \cdot {M}_{RB , b . f . c}^{PUSCH} ( i ) ) + {α}_{b , f , c} ( j ) \cdot {PL}_{b , f , c} ( {q}_{d} ) + {Δ}_{TF , b , f , c} ( i ) + {f}_{b , f , c} ( i , l ) .$$

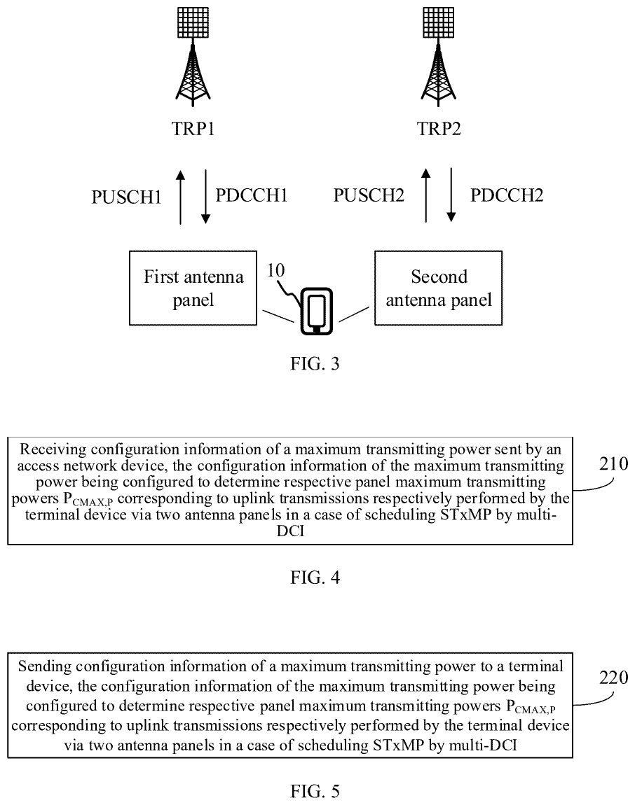

Referring to FIG. 4, FIG. 4 illustrates a flowchart of an uplink power control method provided by an embodiment of the present disclosure, and the method may be applied in the communication system shown in FIG. 1, and is performed by a terminal device. The method includes:
step 210, receiving configuration information of a maximum transmitting power sent by an access network device, the configuration information of the maximum transmitting power being configured to determine respective panel maximum transmitting powers P_{CMAX,P} corresponding to uplink transmissions respectively performed by the terminal device via two antenna panels in a case of scheduling simultaneous transmission via multi-panel (STxMP) by multi-DCI (M-DCI).

The terminal device includes a plurality of antenna panels and supports simultaneous uplink transmissions via the plurality of antenna panels. For example, the terminal device includes two, three, four or more panels. In an embodiment, the terminal device includes two panels: a first panel (first antenna panel) and a second panel (second antenna panel). The terminal device supports simultaneous uplink transmissions via the first panel and the second panel.

In a possible implementation, the panel maximum transmitting power PCMAX,P corresponding to each of the respective uplink transmissions may be determined for up to two antenna panels of the terminal device.

For example, the terminal device receives an RRC message sent by the access network device, and the RRC message carries the configuration information of the maximum transmitting power.

The configuration information of the maximum transmitting power includes one of:
configuration information of a terminal maximum transmitting power PCMAX of the terminal device;
configuration information of respective panel maximum transmitting powers P_{CMAX,P} corresponding to the antenna panels of the terminal device; or
the configuration information of the terminal maximum transmitting power P_{CMAX} of the terminal device, and the configuration information of the respective panel maximum transmitting powers P_{CMAX,P} corresponding to the antenna panels of the terminal device.

That is, the embodiment of the present disclosure provides three configuration types for the maximum transmitting power PCMAX on a certain carrier allowed by the terminal device:
configuration type 1: only the terminal maximum transmitting power P_{CMAX} on a certain carrier determined by a power class is configured for the terminal device;
configuration type 2: the maximum transmitting power P_{CMAX,P} of each panel is configured for terminal device that supports simultaneous transmission via multi-panel;
configuration type 3: both of the above two types of configuration information are configured for the terminal device, i.e., both the maximum transmitting power P_{CMAX} of the terminal device and the maximum transmitting power P_{CMAX,p} of each panel are configured at the same time.

For example, the maximum transmitting power of the terminal device may be referred to as the terminal maximum transmitting power PCMAX, and the maximum transmitting power of the panel may be referred to as the panel maximum transmitting power PCMAX,p. p1 in PCMAX,p1 denotes the panel maximum transmitting power of a panel 1 (a first panel), and p2 in PCMAX,p2 denotes the panel maximum transmitting power of a panel 2 (a second panel).

The terminal device receives a plurality of DCIs sent by the access network device, and the plurality of DCIs schedules a plurality of panels of the terminal device for simultaneous uplink transmissions.

For example, the access network device schedules, via two DCIs, two panels of the terminal device to perform simultaneous uplink transmissions, then the terminal device determines the respective panel maximum transmitting powers PCMAX,p corresponding to the uplink transmissions respectively performed via the two panels based on the configuration information of the maximum transmitting power.

For example, the terminal device determines the respective panel maximum transmitting powers PCMAX,p corresponding to the uplink transmissions respectively performed via the two panels based on the configuration of the maximum transmitting power of the scheduled two panels in the configuration information of the maximum transmitting power.

If the access network device configures the maximum transmitting power for the terminal device using the configuration type 2 or the configuration type 3 as described above, the access network device may configure the respective panel maximum transmitting powers PCMAX,p for some or all of the panels of the terminal device. For example, the terminal device has four panels, and the access network device configures the terminal maximum transmitting power PCMAX for the terminal device, and the respective panel maximum transmitting powers PCMAX,p corresponding to the first panel and the second panel.

The two panels scheduled by the access network device via the two DCIs may be or may not be configured with the panel maximum transmitting powers PCMAX,p, and the terminal device may determine the panel maximum transmitting power PCMAX,p of each panel in a corresponding manner according to the configuration of the maximum transmitting power.

For example, the access network device schedules, via two DCIs, a first panel and a second panel of the terminal device to perform simultaneous uplink transmissions. When the configuration information of the maximum transmitting power includes the terminal maximum transmitting power PCMAX but does not include the panel maximum transmitting powers PCMAX,p of the first panel and the second panel, the terminal device determines the respective panel maximum transmitting powers PCMAX,p corresponding to the first panel and the second panel by using a manner (e.g., a manner I, II, III or IV described below) corresponding to that the configuration information of the maximum transmitting power includes the configuration information of the terminal maximum transmitting power PCMAX.

When the configuration information for the maximum transmitting power does not include the terminal maximum transmitting power PCMAX but includes the panel maximum transmitting powers PCMAX,p of the first panel and the second panel, the terminal device determines the respective panel maximum transmitting powers PCMAX,p corresponding to the first panel and the second panel by using a manner (e.g., a manner V described below) corresponding to that the configuration information of the maximum transmitting power includes the configuration information of the respective panel maximum transmitting powers PCMAX,P corresponding to the antenna panels of the terminal device.

When the configuration information of the maximum transmitting power includes the terminal maximum transmitting power PCMAX and also includes the panel maximum transmitting powers PCMAX,P of the first panel and the second panel, the terminal device determines the respective panel maximum transmitting powers PCMAX,p corresponding to the first panel and the second panel by using a manner (e.g., a manner VI, VII, VIII, or IX described below) corresponding to that the configuration information of the maximum transmitting power includes the configuration information of the terminal maximum transmitting power PCMAX of the terminal device and the configuration information of the respective panel maximum transmitting powers PCMAX,P corresponding to the two antenna panels.

The simultaneous transmission refers to that the transmission occasions of a plurality of uplink transmissions are fully/partially overlapped in a time domain, and corresponding frequency-domain resources may be fully/partially/non-overlapped.

For example, the terminal device receives a first PDCCH sent by the first TRP via the first panel, the first PDCCH includes a first DCI, and the first DCI schedules the first panel to send a first uplink channel (e.g., a PUSCH or PUCCH (physical uplink control channel))/first uplink signal in a first transmission occasion. The terminal device receives a second PDCCH sent by the second TRP via the second panel, the second PDCCH includes a second DCI, and the second DCI schedules the second panel to send a second uplink channel/second uplink signal in a second transmission occasion. The first transmission occasion and the second transmission occasion have an overlapping symbol in the time domain.

In a case of scheduling the STxMP by M-DCI, the terminal device respectively determines respective panel maximum transmitting powers PCMAX,P of uplink transmissions respectively performed via two antenna panels based on the configuration information of the maximum transmitting power. That is, the terminal device determines a first panel maximum transmitting power PCMAX,P1 for the first panel to send a first uplink transmission based on the configuration information of the maximum transmitting power; and the terminal device determines a second panel maximum transmitting power PCMAX,P2 for the second panel to send a second uplink transmission based on the configuration information of the maximum transmitting power.

The configuration information of the maximum transmitting power is configured to determine a first panel maximum transmitting power PCMAX,P1 of the uplink transmission via the first antenna panel in the case of scheduling the STxMP by the M-DCI, and the configuration information of the maximum transmitting power is configured to determine a second panel maximum transmitting power PCMAX,P2 of the uplink transmission via the second antenna panel in the case of scheduling the STxMP by the M-DCI.

For example, the terminal device determines that the panel maximum transmitting power PCMAX,P of the panel is in a symbol level, i.e., the terminal device determines the panel maximum transmitting power PCMAX,P of the panel in each symbol of the transmission occasion.

The first panel is configured to perform a first uplink transmission, the second panel is configured to perform a second uplink transmission, and a first transmission occasion of the first uplink transmission and a second transmission occasion of the second uplink transmission are overlapped in a time domain within a transmission slot. The configuration information of the maximum transmitting power is configured to determine the first panel maximum transmitting power PCMAX,P1 of the first panel in each symbol of the first transmission occasion, and the configuration information of the maximum transmitting power is configured to determine the second panel maximum transmitting power PCMAX,P2 of the second panel in each symbol of the second transmission occasion.

In view of the above, in the method provided in the embodiment, by configuring the configuration information of the maximum transmitting power for the terminal device, the terminal device respectively determines, according to the configuration information of the maximum transmitting power, the maximum transmitting power of the uplink transmission via each panel when scheduling the STxMP by the M-DCI, so as to realize power control of the STxMP.

Referring to FIG. 5, FIG. 5 illustrates a flowchart of an uplink power control method provided in an embodiment of the present disclosure, the method may be applied to the communication system shown in FIG. 1, and is performed by an access network device. The method includes:
step 220: sending configuration information of a maximum transmitting power to a terminal device, the configuration information of the maximum transmitting power being configured to determine respective panel maximum transmitting powers PCMAX,P corresponding to uplink transmissions respectively performed by the terminal device via two antenna panels in a case of scheduling simultaneous transmission via multi-panel (STxMP) by multi-downlink control information (M-DCI).

The terminal device includes a plurality of antenna panels and supports simultaneous uplink transmissions via the plurality of antenna panels.

In a possible implementation, the panel maximum transmitting power PCMAX,P corresponding to each of the respective uplink transmissions may be determined for up to two antenna panels of the terminal device.

For example, the access network device configures a maximum transmitting power for the terminal device.

The access network device may configure a terminal maximum transmitting power PCMAX for the terminal device, and/or the access network device may respectively configure a panel maximum transmitting power PCMAX,p for each panel of the terminal device.

For example, when the access network device schedules a plurality of panels of the terminal device for simultaneous uplink transmissions, the terminal device may respectively determine the panel maximum transmitting power PCMAX,p corresponding to each panel based on the maximum transmitting power configured by the access network device.

For example, the access network device configures the terminal maximum transmitting power PCMAX for the terminal device based on a power class of the terminal device. The power class of the terminal device is a maximum output power of any transmission bandwidth within the channel bandwidth of the NR carrier. The power class of the terminal device corresponds to a maximum transmitting power PCMAX, or corresponds to a value range of the maximum transmitting power PCMAX.

The embodiment of the present disclosure provides an power control enhancement solution for simultaneous uplink transmissions via multi-panel based on M-DCI scheduling, which provides a plurality of power enhancement control solutions for uplink transmissions (e.g., PUSCH) via different panels with an overlapping time domain and an overlapping or non-overlapping frequency domain in a transmission occasion of the same slot, in order to achieve simultaneous uplink transmissions from a plurality of panels to a plurality of TRPs, thereby improving throughput rate and transmission reliability of the uplink transmission.

In view of the above, in the method provided in the embodiment, by configuring the configuration information of the maximum transmitting power for the terminal device, the terminal device respectively determines, according to the configuration information of the maximum transmitting power, the maximum transmitting power of the uplink transmission via each panel when scheduling the STxMP by the M-DCI, so as to realize power control of the STxMP.

For example, an embodiment in which a terminal device interacts with an access network device is given.

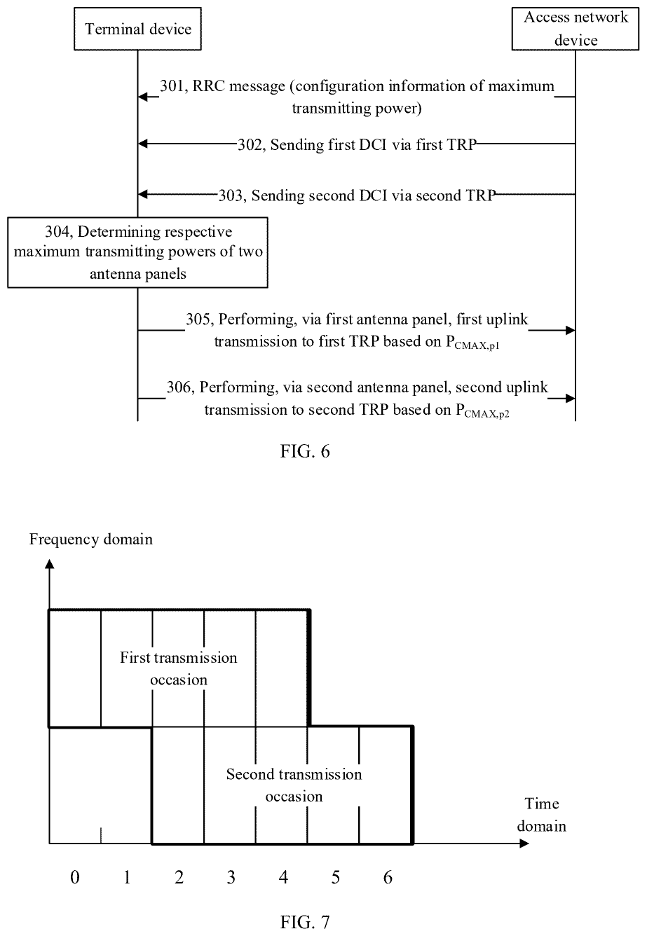

Referring to FIG. 6, FIG. 6 illustrates a flowchart of an uplink power control method provided by an embodiment of the present disclosure, and the method may be applied to the communication system shown in FIG. 1, and is performed by a terminal device and an access network device. The method includes the following steps.

In step 301, the access network device sends an RRC message to the terminal device, the RRC message including configuration information of a maximum transmitting power.

The access network device configures the maximum transmitting power for the terminal device via the RRC message. The terminal device receives the RRC message sent by the access network device and reads the configuration information of the maximum transmitting power in the RRC message.

For example, the access network device configures a terminal maximum transmitting power PCMAX for the terminal device.

Alternatively, the access network device configures a first panel maximum transmitting power PCMAX,p1 and a second panel maximum transmitting power PCMAX,p2 for the terminal device.

Alternatively, the access network device configures the terminal maximum transmitting power PCMAX, the first panel maximum transmitting power PCMAX,p1 and the second panel maximum transmitting power PCMAX,p2 for the terminal device.

In step 302, the access network device sends a first DCI to a first panel of the terminal device via a first TRP.

The first DCI is configured to schedule the terminal device to send a first uplink channel (e.g., PUSCH or PUCCH)/first uplink signal (e.g., SRS (sounding reference signal)) to the first TRP via the first panel in a first transmission occasion.

In step 303, the access network device sends a second DCI to a second panel of the terminal device via a second TRP.

The second DCI is configured to schedule the terminal device to send a second uplink channel (e.g., PUSCH or PUCCH)/second uplink signal (e.g., SRS) to the second TRP via the second panel in a second transmission occasion.

The first transmission occasion and the second transmission occasion have an overlapping symbol in the time domain. For example, as shown in FIG. 7, the first transmission occasion includes symbol 0 to symbol 4, and the second transmission occasion includes symbol 2 to symbol 6. The first transmission occasion and the second transmission occasion have overlapping symbols in the time domain, i.e., symbol 2 to symbol 4.

The first transmission occasion and the second transmission occasion are overlapped/partially overlapped/not overlapped in the frequency domain.

That is, the access network device schedules the first panel and the second panel for simultaneous uplink transmissions via the multi-DCI.

In step 304, in a case of scheduling STxMP by M-DCI, the terminal device respectively determines panel maximum transmitting powers PCMAX,P of a plurality of panels based on the configuration information of the maximum transmitting power.

In a possible implementation, the panel maximum transmitting power PCMAX,P corresponding to each of the respective uplink transmissions may be determined for up to two antenna panels of the terminal device.

For example, an embodiment of the present disclosure provides various manners for determining the panel maximum transmitting powers PCMAX,p for respective panels depending on different configuration types of the maximum transmitting power, which are to be described in subsequent embodiments.

For example, the first transmission occasion and the second transmission occasion have an overlapping symbol in the time domain, and the overlapping symbol includes at least one symbol. The terminal device determines a first panel maximum transmitting power PCMAX,p1 of the first panel in the overlapping symbol based on the configuration information of the maximum transmitting power; and determines a second panel maximum transmitting power PCMAX,p2 of the second panel in the overlapping symbol based on the configuration information of the maximum transmitting power.

In an embodiment, the first transmission occasion also includes a first non-overlapping symbol that does not overlap with the second transmission occasion, and the first non-overlapping symbol includes at least one symbol. The terminal device determines the first panel maximum transmitting power PCMAX,p1 of the first panel in the first non-overlapping symbol based on the configuration information of the maximum transmitting power.

In an embodiment, the second transmission occasion also includes a second non-overlapping symbol that does not overlap with the first transmission occasion, and the second non-overlapping symbol includes at least one symbol. The terminal device determines the second panel maximum transmitting power PCMAX,p2 of the second panel in the second non-overlapping symbol based on the configuration information of the maximum transmitting power.

In step 305, the terminal device performs, via the first panel, a first uplink transmission to the first TRP based on the first panel maximum transmitting power PCMAX,p1.

For example, the terminal device controls the transmitting powers of the respective panels based on the panel maximum transmitting powers PCMAX,p of the respective panels.

For example, the terminal device controls the transmitting power of the first panel for sending a PUSCH in respective symbols of the first transmission occasion based on Formula II. Formula II:

$${P}_{P U SCH , p 1 , p , f , c} ( i , j , {q}_{d} , l , a ) = min \{ \begin{matrix}{P}_{CMAX , p 1 , f , c} ( i , a ) ; \\ {P}_{{O \_}_{PUSCH ,} b , f , c} ( j ) + 10 {log}_{10} ( {2}^{μ} \cdot {M}_{RB , b . f . c}^{PUSCH} ( i ) ) + {α}_{b , f , c} ( j ) \cdot {PL}_{b , f , c} ( {q}_{d} ) + {Δ}_{TF , b , f , c} ( i ) + {f}_{b , f , c} ( i , l )\end{matrix}$$

where P_{PUSCH,p1,p,f,c}(i, j, q_{d}, l, a) is a transmitting power of the terminal device for sending, via the first panel, a PUSCH in an a^{th} symbol of an i^{th} transmission occasion; P_{CMAX,p1,f,c}(i, a) is a maximum transmitting power of the first panel for sending the PUSCH in the a^{th} symbol of the i^{th} transmission occasion; P_{O}_{_{_PUSCH}}_{,b,f,c}(j) is a target power value corresponding to the PUSCH sent by the first panel, which is given by a parameter configured by a high-level signaling, and the base station may configure a plurality of parameter sets for the terminal device, and j is the index of the parameter set; P_{O}_{_{_PUSCH}}_{,b,f,c}(j)=P_{O}_{_{_NOMINAL_PUSCH}}_{,b,f}(j)+P_{O_UE}_{_{_PUSCH}}_{,b,f,c}(j), P_{O}_{_{_NOMINAL_PUSCH}}_{,b,f}(j) is a desired received power of PUSCH at a cell level, and P_{O_UE}_{_{_PUSCH}}_{,b,f,c}(j) is a power deviation of PUSCH at a UE level in dynamic scheduling; μ is a NR parameter set corresponding to the PUSCH sent by the first panel, which relates to a subcarrier spacing;

$${M}_{RB , b . f . c}^{P U S C H} ( i )$$

is the number of RBs (resource block) occupied by the first panel of the terminal device to send the PUSCH in the i^{th} PUSCH transmission occasion; α_{b,f,c}(j) is a path loss compensation factor corresponding to the PUSCH sent by the first panel, and j is an index of the parameter set; PL_{b,f,c}(q_{d}) is a path loss corresponding to the PUSCH sent by the first panel; Δ_{TF,b,f,c}(i) denotes a power offset determined by an MCS (modulation and coding solution) class; and f_{b,f,c}(i, l) is a closed-loop power control adjusted value corresponding to the PUSCH sent by the first panel, and l is an index of closed-loop power control state corresponding to the PUSCH sent by the first panel, which is obtained by TPC information mapping in PDCCH.

That is, the transmitting power of the terminal device for sending, via the first panel, the first PUSCH in symbol a is a minimum value between the maximum transmitting power of the first panel for sending the PUSCH in the symbol a

$${P}_{C M AX , p 1 , f , c} ( i , a ) and {P}_{{O\_}_{PUSCH ,} b , f , c} ( j ) + 10 {log}_{10} ( {2}^{μ} \cdot {M}_{RB , b , f , c}^{PUSCH} ( i ) ) + {α}_{b , f , c} ( j ) \cdot {PL}_{b , f , c} ( {q}_{d} ) + {Δ}_{TF , b , f , c} ( i ) + {f}_{b , f , c} ( i , l ) .$$

In step 306, the terminal device performs, via the second panel, a second uplink transmission to the second TRP based on the second panel maximum transmitting power P_{CMAX,p2}.

For example, the terminal device controls the transmitting power of the second panel for sending a PUSCH in respective symbols of the second transmission occasion based on Formula III.

$${P}_{P U SCH , p 2 , p , f , c} ( i , j , {q}_{d} , l , a ) = min \{ \begin{matrix}{P}_{CMAX , p 2 , f , c} ( i , a ) ; \\ {P}_{{O \_}_{PUSCH ,} b , f , c} ( j ) + 10 {log}_{10} ( {2}^{μ} \cdot {M}_{RB , b . f . c}^{PUSCH} ( i ) ) + {α}_{b , f , c} ( j ) \cdot {PL}_{b , f , c} ( {q}_{d} ) + {Δ}_{TF , b , f , c} ( i ) + {f}_{b , f , c} ( i , l )\end{matrix} \qquad Formula III$$

where P_{PUSCH,p2,p,f,c}(i, j, q_{d}, l, a) is a transmitting power of the terminal device for sending, via the second panel, a PUSCH in an a^{th} symbol of an i^{th} transmission occasion; P_{CMAX,p2,f,c}(i, a) is a maximum transmitting power of the second panel for sending the PUSCH in the a^{th} symbol of the i^{th} transmission occasion; P_{O}_{_{_PUSCH}}_{,b,f,c}(j) is a target power value corresponding to the PUSCH sent by the second panel, which is given by a parameter configured by a high-level signaling, and the base station may configure a plurality of parameter sets for the terminal device, and j is the index of the parameter set; P_{O}_{_{_PUSCH}}_{,b,f,c}(j)=P_{O}_{_{_NOMINAL_PUSCH}}_{,b,f}(j)+P_{O_UE}_{_{_PUSCH}}_{,b,f,c}(j), P_{O}_{_{_NOMINAL_PUSCH}}_{,b,f}(j) is a desired received power of PUSCH at a cell level, and P_{O_UE}_{_{_PUSCH}}_{,b,f,c}(j) is a power deviation of PUSCH at a UE level in dynamic scheduling; μ is a NR parameter set corresponding to the PUSCH sent by the second panel, which relates to a subcarrier spacing;

$${M}_{RB , b . f . c}^{P U S C H} ( i )$$

is the number of RBs (resource block) occupied by the second panel of the terminal device to send the PUSCH in the i^{th} PUSCH transmission occasion; α_{b,f,c}(j) is a path loss compensation factor corresponding to the PUSCH sent by the second panel, and j is an index of the parameter set; PL_{b,f,c}(q_{d}) is a path loss corresponding to the PUSCH sent by the second panel; Δ_{TF,b,f,c}(i) denotes a power offset determined by an MCS class; and f_{b,f,c}(i, l) is a closed-loop power control adjusted value corresponding to the PUSCH sent by the second panel, and l is an index of closed-loop power control state corresponding to the PUSCH sent by the second panel, which is obtained by TPC information mapping in PDCCH.

That is, the transmitting power of the terminal device for sending, via the second panel, the second PUSCH in symbol a is a minimum value between the maximum transmitting power of the second panel for sending the PUSCH in the symbol a

$${P}_{C M AX , p 2 , f , c} ( i , a ) and {P}_{{O \_}_{PUSCH ,} b , f , c} ( j ) + 10 {log}_{10} ( {2}^{μ} \cdot {M}_{RB , b . f . c}^{PUSCH} ( i ) ) + {α}_{b , f , c} ( j ) \cdot {PL}_{b , f , c} ( {q}_{d} ) + {Δ}_{TF , b , f , c} ( i ) + {f}_{b , f , c} ( i , l ) .$$

In view of the above, in the method provided in the embodiment, by configuring the configuration information of the maximum transmitting power for the terminal device, when scheduling the STxMP by the M-DCI, the terminal device respectively determines, according to the configuration information of the maximum transmitting power, the maximum transmitting power of the uplink transmission via each panel, and then determines, according to the maximum transmitting power corresponding to each panel, the transmitting power of the uplink transmission via each panel, so as to realize power control of the uplink transmission. Moreover, for the case where a plurality of uplink transmission occasions are overlapped in the time domain, the panel maximum transmitting powers of one panel in respective symbols of the transmission occasion may be determined respectively, so as to achieve power control at the symbol level, thereby improving the precision of power control.

For example, in view of different configurations of the maximum transmitting power of the scheduled two panels, an embodiment of the present disclosure provides a plurality of methods for determining the panel maximum transmitting power of each panel.
1. The configuration information of the maximum transmitting power includes configuration information of a terminal maximum transmitting power PCMAX of the terminal device.

The respective panel maximum transmitting powers PCMAX,P corresponding to the uplink transmissions respectively performed via the two antenna panels are determined by one of the following manners.

In a possible implementation, the respective panel maximum transmitting powers PCMAX,P corresponding to the respective uplink transmissions may be determined for up to two antenna panels of the terminal device by one of the following manners.

Manner I: the respective panel maximum transmitting powers PCMAX,P corresponding to the uplink transmissions respectively performed via the two antenna panels are obtained by dividing the terminal maximum transmitting power PCMAX equally.

For example, the access network device sends the configuration information of the terminal maximum transmitting power PCMAX to the terminal device, and configures the terminal maximum transmitting power PCMAX as 26 dbm, then the first panel maximum transmitting power of the first panel is ½*26 dbm=23 dbm, and the second panel maximum transmitting power of the second panel is ½*26 dbm=23 dbm.

Manner II: The respective panel maximum transmitting powers PCMAX,P corresponding to the uplink transmissions respectively performed via the two antenna panels are obtained by allocating the terminal maximum transmitting power PCMAX based on a power allocation factor, wherein the power allocation factor is predefined, or configured by the network device, or reported by the terminal device.

For example, the power allocation factor is a ratio A of the first panel maximum transmitting power PCMAX,P1 to the second panel maximum transmitting power PCMAX,P2, i.e., A=PCMAX,P1/PCMAX,P2. Then the first panel maximum transmitting power PCMAX,P1 is equal to A*PCMAX/(1+A), and the second panel maximum transmitting power PCMAX,P2 is equal to PCMAX/(1+A).

Alternatively, the first panel has a first power allocation factor a, and the second panel has a second power allocation factor b, and a+b=1. Then the first panel maximum transmitting power PCMAX,P1 is equal to a*PCMAX, and the second panel maximum transmitting power PCMAX,P2 is equal to b*PCMAX.

For example, the terminal device receives configuration information of the power allocation factor sent by the access network device. Alternatively, the terminal device reads the power allocation factor stored locally. Alternatively, the terminal device reports the power allocation factor to the access network device.

For example, the terminal device determines the power allocation factor based on the transmission capabilities of the two panels and reports the power allocation factor to the access network device.

Manner III: The respective panel maximum transmitting powers PCMAX,P corresponding to the uplink transmissions respectively performed via the two antenna panels are determined based on indication information, and the indication information is configured to indicate the respective panel maximum transmitting powers PCMAX,P of the two antenna panels.

In an embodiment, the access network device sends the indication information to the terminal device, and the indication information is configured to indicate the panel maximum transmitting power PCMAX,P1 of the first panel and the panel maximum transmitting power PCMAX,P2 of the second panel.

For example, the two antenna panels of the terminal device include a first antenna panel and a second antenna panel, the first antenna panel is used to perform a first uplink transmission in a first transmission occasion, and the second antenna panel is used to perform a second uplink transmission in a second transmission occasion, and the first transmission occasion and the second transmission occasion have an overlapping symbol within the transmission slot. For example, as shown in FIG. 7, there are overlapping symbols between the first transmission occasion and the second transmission occasion within the transmission slot, i.e., symbol 2, symbol 3, symbol 4.

In an embodiment, the first transmission occasion also includes a first non-overlapping symbol that does not overlap with the second transmission occasion within the transmission slot. For example, the first transmission occasion also includes the first non-overlapping symbols, i.e., symbol 0, symbol 1, which do not overlap with the second transmission occasion within the transmission slot.

In an embodiment, the second transmission occasion also includes a second non-overlapping symbol that does not overlap with the first transmission occasion within the transmission slot. For example, the second transmission occasion also includes the second non-overlapping symbols, i.e., symbol 5, symbol 6, which do not overlap with the first transmission occasion within the transmission slot.

For example, for the overlapping relationship of the symbols in the two transmission occasions described above, the panel maximum transmitting power of the panel is determined for each symbol respectively.

For the overlapping symbol, the panel maximum transmitting power of the panel in each symbol may be determined respectively using the above described manner I, manner II or manner III.

That is, for the uplink transmission in the overlapping symbol, the respective panel maximum transmitting powers PCMAX,P corresponding to the uplink transmissions respectively performed via the two antenna panels are determined by one of:
manner I: obtaining the respective panel maximum transmitting powers PCMAX,P corresponding to the uplink transmissions respectively performed via the first antenna panel and the second antenna panel by dividing the terminal maximum transmitting power PCMAX equally;
manner II: obtaining the respective panel maximum transmitting powers PCMAX,P corresponding to the uplink transmissions respectively performed via the first antenna panel and the second antenna panel by allocating the terminal maximum transmitting power PCMAX based on a power allocation factor, wherein the power allocation factor is predefined, or is configured by the network device, or is reported by the terminal device; and
manner III: determining the respective panel maximum transmitting powers PCMAX,P corresponding to the uplink transmissions respectively performed via the first antenna panel and the second antenna panel based on indication information, the indication information being configured to indicate the respective panel maximum transmitting powers PCMAX,P of the two antenna panels.

For the non-overlapping symbol, the panel maximum transmitting power of the panel in each symbol may be determined respectively using the above described manner I, manner II or manner III. Alternatively, the terminal maximum transmitting power is directly determined as the panel maximum transmitting power of the panel in the non-overlapping symbol.

That is, for the first uplink transmission in the first non-overlapped symbol, the first panel maximum transmitting power PCMAX,P1 corresponding to the first uplink transmission via the first antenna panel is determined by one of:
manner I: obtaining the first panel maximum transmitting power PCMAX,P1 corresponding to the first uplink transmission via the first antenna panel by dividing the terminal maximum transmitting power PCMAX equally;
manner II: obtaining the first panel maximum transmitting power PCMAX,P1 corresponding to the first uplink transmission via the first antenna panel by allocating the terminal maximum transmitting power PCMAX based on the power allocation factor, wherein the power allocation factor is predefined, or is configured by the network device, or is reported by the terminal device;
manner III: determining the first panel maximum transmitting power PCMAX,P1 corresponding to the first uplink transmission via the first antenna panel based on the indication information, the indication information being configured to indicate the respective panel maximum transmitting powers P_{CMAX,P} of the two antenna panels; or
manner IV: determining the terminal maximum transmitting power PCMAX as the first panel maximum transmitting power PCMAX,P1 corresponding to the first uplink transmission via the first antenna panel.

For the second uplink transmission in the second non-overlapped symbol, the second panel maximum transmitting power PCMAX,P2 corresponding to the second uplink transmission via the second antenna panel is determined by one of:
manner I: obtaining the second panel maximum transmitting power PCMAX,P2 corresponding to the second uplink transmission via the second antenna panel by dividing the terminal maximum transmitting power PCMAX equally;
manner II: obtaining the second panel maximum transmitting power PCMAX,P2 corresponding to the second uplink transmission via the second antenna panel by allocating the terminal maximum transmitting power PCMAX based on the power allocation factor, wherein the power allocation factor is predefined, or is configured by the network device, or is reported by the terminal device;
manner III: determining the second panel maximum transmitting power PCMAX,P2 corresponding to the second uplink transmission via the second antenna panel based on the indication information, the indication information being configured to indicate the respective panel maximum transmitting powers PCMAX,P of the two antenna panels; or
manner IV: determining the terminal maximum transmitting power PCMAX as the second panel maximum transmitting power PCMAX,P2 corresponding to the second uplink transmission via the second antenna panel.
2. The configuration information of the maximum transmitting power includes configuration information of respective panel maximum transmitting powers PCMAX,P corresponding to the first panel and the second panel.

For example, the two antenna panels include a first antenna panel and a second antenna panel, and the configuration information of the maximum transmitting power incudes configuration information of a first panel maximum transmitting power PCMAX,P1 of the first antenna panel and a second panel maximum transmitting power PCMAX,P2 of the second antenna panel.

In a possible implementation, the respective panel maximum transmitting powers PCMAX,P corresponding to the respective uplink transmissions may be determined for up to two antenna panels of the terminal device by one of the following manners.

Manner V: The panel maximum transmitting power PCMAX,P of a first uplink transmission via the first antenna panel is the first panel maximum transmitting power PCMAX,P1, and the panel maximum transmitting power PCMAX,P of a second uplink transmission via the second antenna panel is the second panel maximum transmitting power PCMAX,P2.

In the case where the access network device configures a panel maximum transmitting power for each panel, the power control of each panel is performed based on the panel maximum transmitting power of the corresponding panel.

For example, the panel maximum transmitting power PCMAX,P of the first panel in each symbol (including the overlapping symbol and the non-overlapping symbol) of the first transmission occasion is determined to be the first panel maximum transmitting power PCMAX,P1, and the panel maximum transmitting power PCMAX,P of the second panel in each symbol (including the overlapping symbol and the non-overlapping symbol) of the second transmission occasion is determined to be the second panel maximum transmitting power PCMAX,P2.
3. The configuration information of the maximum transmitting power includes configuration information of a terminal maximum transmitting power PCMAX of the terminal device and configuration information of respective panel maximum transmitting powers PCMAX,P corresponding to the first panel and the second panel.

That is, the two antenna panels include a first antenna panel and a second antenna panel, and the configuration information of the maximum transmitting power comprises: configuration information of a terminal maximum transmitting power PCMAX of the terminal device, and configuration information of a first panel maximum transmitting power PCMAX,P1 of the first antenna panel and a second panel maximum transmitting power PCMAX,P2 of the second antenna panel.

The first antenna panel is configured to perform a first uplink transmission in a first transmission occasion, the second antenna panel is configured to perform a second uplink transmission in a second transmission occasion, and the first transmission occasion and the second transmission occasion have an overlapping symbol within a transmission slot.

In an embodiment, the first transmission occasion further includes a first non-overlapping symbol that does not overlap with the second transmission occasion in the transmission slot.

In an embodiment, the second transmission occasion further includes a second non-overlapping symbol that does not overlap with the first transmission occasion in the transmission slot.

Since the maximum transmitting power of the terminal device in each symbol does exceed PCMAX, for the relationship between PCMAX and PCMAX,P1+PCMAX,P2, the following manners of determining the panel maximum transmitting powers of the respective panels are provided.

Manner VI: In a case where the terminal maximum transmitting power PCMAX is greater than a sum of the first panel maximum transmitting power PCMAX,P1 and the second panel maximum transmitting power PCMAX,P2, the panel maximum transmitting power PCMAX,P of a first uplink transmission via the first antenna panel is the first panel maximum transmitting power PCMAX,P1, and the panel maximum transmitting power PCMAX,P of a second uplink transmission via the second antenna panel is the second panel maximum transmitting power PCMAX,P2.

That is, when PCMAX>PCMAX,P1+PCMAX,P2, the panel maximum transmitting power of each panel may be controlled according to the PCMAX,P configured for each panel.

Manner VII: In a case where the terminal maximum transmitting power PCMAX is less than or equal to a sum of the first panel maximum transmitting power PCMAX,P1 and the second panel maximum transmitting power PCMAX,P2, the panel maximum transmitting power PCMAX,P of the first uplink transmission via the first antenna panel in the overlapping symbol is a half of the first panel maximum transmitting power PCMAX,P1, and the panel maximum transmitting power PCMAX,P of the second uplink transmission via the second antenna panel in the overlapping symbol is a half of the second panel maximum transmitting power PCMAX,P2.

That is, when PCMAX≤PCMAX,P1+PCMAX,P2, the panel maximum transmitting power of each panel in the overlapping symbol is returned to be ½ of the configuration, i.e., ½*PCMAX,P.

For example, the terminal maximum transmitting power PCMAX configured by the access network device for the terminal device is 26 dbm, the first panel maximum transmitting power PCMAX,P1 of the first panel is 26 dbm, and the second panel maximum transmitting power PCMAX,P2 of the second panel is 26 dbm, so 26 dbm≤26 dbm+26 dbm. Then the panel maximum transmitting power of the first panel is ½*first panel maximum transmitting power PCMAX,P1: ½*26 dbm=23 dbm, and the panel maximum transmitting power of the second panel is ½*second panel maximum transmitting power PCMAX,P2: ½*26 dbm=23 dbm.

For example, when PCMAX≤PCMAX,P1+PCMAX,P2, if the first panel and the second panel have the same transmission capability, the panel maximum transmitting power PCMAX,P of the first uplink transmission via the first antenna panel in the overlapping symbol is ½*PCMAX,P1, and the panel maximum transmitting power of the second uplink transmission via the second antenna panel in the overlapping symbol is ½*PCMAX,P2. The same transmission capability may refer to that two power amplifiers (PA) corresponding to the two panels have the same capability.

Manner VIII: In the case where the terminal maximum transmitting power PCMAX is less than or equal to the sum of the first panel maximum transmitting power PCMAX,P1 and the second panel maximum transmitting power PCMAX,P2, the panel maximum transmitting power PCMAX,P of the first uplink transmission via the first antenna panel in the overlapping symbol is a quotient obtained by dividing the first panel maximum transmitting power PCMAX,P1 by a first capability factor, and the panel maximum transmitting power PCMAX,P of the second uplink transmission via the second antenna panel in the overlapping symbol is a quotient obtained by dividing the second panel maximum transmitting power PCMAX,P2 by a second capability factor, wherein the first capability factor is determined based on a transmission capability of the first antenna panel, and the second capability factor is determined based on a transmission capability of the second antenna panel.

That is, when PCMAX≤PCMAX,P1+PCMAX,P2, the panel maximum transmitting power of each panel in the overlapping symbol is returned to 1/B of the configuration, i.e., 1/B* PCMAX,P, wherein B is the capability factor determined based on the transmission capability of a respective panel.

For example, the terminal maximum transmitting power PCMAX configured by the access network device for the terminal device is 26 dbm, the first panel maximum transmitting power PCMAX,P1 of the first panel is 26 dbm, and the second panel maximum transmitting power PCMAX,P2 of the second panel is 26 dbm, so 26 dbm≤26 dbm+26 dbm. The first capability factor of the first panel is 2, and the second capability factor of the second panel is 4, then the panel maximum transmitting power of the first panel is ½*first panel maximum transmitting power PCMAX,P1: ½*26 dbm=23 dbm, and the panel maximum transmitting power of the second panel is ¼*second panel maximum transmitting power PCMAX,P2: ¼*26 dbm=20 dbm.

For example, when PCMAX≤PCMAX,P1+PCMAX,P2, if the transmission capabilities of the first panel and the second panel are different, the panel maximum transmitting power PCMAX,P of the first uplink transmission via the first antenna panel in the overlapping symbol is PCMAX,P1/B1, and the panel maximum transmitting power PCMAX,P of the second uplink transmission via the second antenna panel in the overlapping symbol is PCMAX,P2/B2, wherein Bl is determined based on the transmission capability of the first antenna panel, and B2 is determined based on the transmission capability of the second antenna panel. For example, the stronger the transmission capability of the panel is, the smaller the capability factor thereof is. The different transmission capabilities may refer to that two power amplifiers (PA) corresponding to the two panels have different capabilities.

Manner IX: In the case where the terminal maximum transmitting power PCMAX is less than or equal to the sum of the first panel maximum transmitting power PCMAX,P1 and the second panel maximum transmitting power PCMAX,P2, the panel maximum transmitting power PCMAX,P of the first uplink transmission via the first antenna panel in the first non-overlapping symbol is the first panel maximum transmitting power PCMAX,P1. In the case where the terminal maximum transmitting power PCMAX is less than or equal to the sum of the first panel maximum transmitting power PCMAX,P1 and the second panel maximum transmitting power PCMAX,P2, the panel maximum transmitting power PCMAX,P of the second uplink transmission via the second antenna panel in the second non-overlapping symbol is the second panel maximum transmitting power PCMAX,P2.

That is, when PCMAX≤PCMAX,P1+PCMAX,P2, the panel maximum transmitting power of each panel in the overlapping symbol may be controlled based on the PCMAX,P configured for the respective panel.

It is to be noted that the foregoing description of the configuration information of the maximum transmitting power may also be applied in the embodiment performed by the terminal device as described in step 210; and may also be applied in the embodiment performed by the access network device as described in step 220, which will not be repeated in the present disclosure.

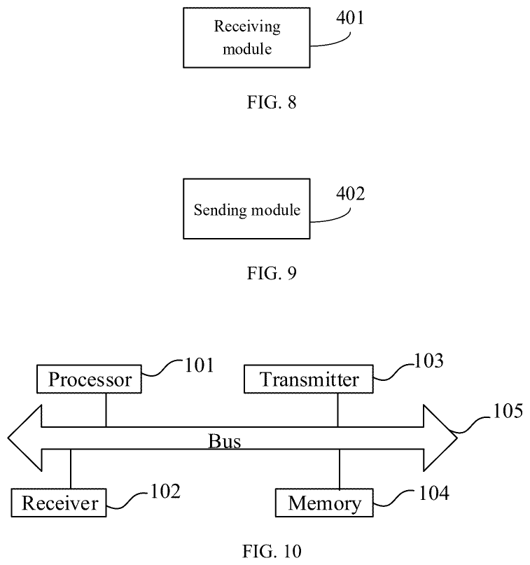

FIG. 8 illustrates a structural block diagram of an uplink power control device provided by an embodiment of the present disclosure. The device may be realized as a terminal device or as a part of a terminal device. The device includes:
a receiving module 401, configured to receive configuration information of a maximum transmitting power sent by an access network device, the configuration information of the maximum transmitting power being configured to determine respective panel maximum transmitting powers PCMAX,P corresponding to uplink transmissions respectively performed by the terminal device via two antenna panels in a case of scheduling simultaneous transmission via multi-panel (STxMP) by multi-downlink control information (M-DCI),
wherein the terminal device includes a plurality of antenna panels and supports simultaneous uplink transmissions via the plurality of antenna panels.

In an embodiment, the two antenna panels include a first antenna panel and a second antenna panel,
the configuration information of the maximum transmitting power is configured to determine a first panel maximum transmitting power PCMAX,P1 of the uplink transmission via the first antenna panel in the case of scheduling the STxMP by the M-DCI, and
the configuration information of the maximum transmitting power is configured to determine a second panel maximum transmitting power PCMAX,P2 of the uplink transmission via the second antenna panel in the case of scheduling the STxMP by the M-DCI.

In an embodiment, the first antenna panel is configured to perform a first uplink transmission, the second antenna panel is configured to perform a second uplink transmission, and a first transmission occasion of the first uplink transmission and a second transmission occasion of the second uplink transmission are overlapped in a time domain within a transmission slot,
the configuration information of the maximum transmitting power is configured to determine the first panel maximum transmitting power PCMAX,P1 of the first antenna panel in each symbol of the first transmission occasion, and
the configuration information of the maximum transmitting power is configured to determine the second panel maximum transmitting power PCMAX,P2 of the second antenna panel in each symbol of the second transmission occasion.

In an embodiment, the receiving module 401 is configured to receive, via the first antenna panel, first DCI sent by a first transmission-reception point (TRP), the first DCI being configured to schedule the first antenna panel to perform the first uplink transmission in the first transmission occasion; and
the receiving module 401 is configured to receive, via the second antenna panel, second DCI sent by a second TRP, the second DCI being configured to schedule the second antenna panel to perform the second uplink transmission in the second transmission occasion.

In an embodiment, the configuration information of the maximum transmitting power includes one of:
configuration information of a terminal maximum transmitting power PCMAX of the terminal device;
configuration information of respective panel maximum transmitting powers PCMAX,P corresponding to the antenna panels of the terminal device; or
the configuration information of the terminal maximum transmitting power PCMAX of the terminal device, and the configuration information of the respective panel maximum transmitting powers PCMAX,P corresponding to the antenna panels of the terminal device.

In an embodiment, the receiving module 401 is configured to receive a radio resource control (RRC) message sent by the access network device, the RRC message including the configuration information of the maximum transmitting power.

In an embodiment, the configuration information of the maximum transmitting power includes the configuration information of the terminal maximum transmitting power PCMAX of the terminal device,
the respective panel maximum transmitting powers PCMAX,P corresponding to the uplink transmissions respectively performed via the two antenna panels are determined by one of:
obtaining the respective panel maximum transmitting powers PCMAX,P corresponding to the uplink transmissions respectively performed via the two antenna panels by dividing the terminal maximum transmitting power PCMAX equally; or
obtaining the respective panel maximum transmitting powers PCMAX,P corresponding to the uplink transmissions respectively performed via the two antenna panels by allocating the terminal maximum transmitting power PCMAX based on a power allocation factor; or
determining the respective panel maximum transmitting powers PCMAX,P corresponding to the uplink transmissions respectively performed via the two antenna panels based on indication information, the indication information being configured to indicate the respective panel maximum transmitting powers PCMAX,P of the two antenna panels,
wherein the power allocation factor is predefined, or is configured by the network device, or is reported by the terminal device.

In an embodiment, the two antenna panels include a first antenna panel and a second antenna panel, the first antenna panel is configured to perform a first uplink transmission in a first transmission occasion, the second antenna panel is configured to perform a second uplink transmission in a second transmission occasion, and the first transmission occasion and the second transmission occasion have an overlapping symbol within a transmission slot,
for the uplink transmission in the overlapping symbol, the respective panel maximum transmitting powers PCMAX,P corresponding to the uplink transmissions respectively performed via the two antenna panels are determined by one of:
obtaining the respective panel maximum transmitting powers PCMAX,P corresponding to the uplink transmissions respectively performed via the first antenna panel and the second antenna panel by dividing the terminal maximum transmitting power PCMAX equally; or
obtaining the respective panel maximum transmitting powers PCMAX,P corresponding to the uplink transmissions respectively performed via the first antenna panel and the second antenna panel by allocating the maximum transmitting power PCMAX based on the power allocation factor; or
determining the respective panel maximum transmitting powers PCMAX,P corresponding to the uplink transmissions respectively performed via the first antenna panel and the second antenna panel based on the indication information, the indication information being configured to indicate the respective panel maximum transmitting powers PCMAX,P of the two antenna panels,
wherein the power allocation factor is predefined, or is configured by the network device, or is reported by the terminal device.

In an embodiment, the first transmission occasion further includes a first non-overlapping symbol that does not overlap with the second transmission occasion in the transmission slot,
for the first uplink transmission in the first non-overlapping symbol, a first panel maximum transmitting power PCMAX,P1 corresponding to the first uplink transmission via the first antenna panel is determined by one of:
determining the terminal maximum transmitting power PCMAX as the first panel maximum transmitting power PCMAX,P1 corresponding to the first uplink transmission via the first antenna panel; or
obtaining the first panel maximum transmitting power PCMAX,P1 corresponding to the first uplink transmission via the first antenna panel by dividing the terminal maximum transmitting power PCMAX equally; or
obtaining the first panel maximum transmitting power PCMAX,P1 corresponding to the first uplink transmission via the first antenna panel by allocating the terminal maximum transmitting power PCMAX based on the power allocation factor; or
determining the first panel maximum transmitting power PCMAX,P1 corresponding to the first uplink transmission via the first antenna panel based on the indication information, the indication information being configured to indicate the respective panel maximum transmitting powers PCMAX,P of the two antenna panels,
wherein the power allocation factor is predefined, or is configured by the network device, or is reported by the terminal device.

In an embodiment, the second transmission occasion further includes a second non-overlapping symbol that does not overlap with the first transmission occasion in the transmission slot,
for the second uplink transmission in the second non-overlapping symbol, a second panel maximum transmitting power PCMAX,P2 corresponding to the second uplink transmission via the second antenna panel is determined by one of:
determining the terminal maximum transmitting power PCMAX as the second panel maximum transmitting power PCMAX,P2 corresponding to the second uplink transmission via the second antenna panel; or
obtaining the second panel maximum transmitting power PCMAX,P2 corresponding to the second uplink transmission via the second antenna panel by dividing the terminal maximum transmitting power PCMAX equally; or
obtaining the second panel maximum transmitting power PCMAX,P2 corresponding to the second uplink transmission via the second antenna panel by allocating the terminal maximum transmitting power PCMAX based on the power allocation factor; or
determining the second panel maximum transmitting power PCMAX,P2 corresponding to the second uplink transmission via the second antenna panel based on the indication information, the indication information being configured to indicate the respective panel maximum transmitting powers PCMAX,P of the two antenna panels,
wherein the power allocation factor is predefined, or is configured by the network device, or is reported by the terminal device.

In an embodiment, the two antenna panels include a first antenna panel and a second antenna panel,
the configuration information of the maximum transmitting power includes configuration information of a first panel maximum transmitting power PCMAX,P1 of the first antenna panel and a second panel maximum transmitting power PCMAX,P2 of the second antenna panel,
the panel maximum transmitting power PCMAX,P of a first uplink transmission via the first antenna panel is the first panel maximum transmitting power PCMAX,P1, and
the panel maximum transmitting power PCMAX,P of a second uplink transmission via the second antenna panel is the second panel maximum transmitting power PCMAX,P2.

In an embodiment, the two antenna panels include a first antenna panel and a second antenna panel, and
the configuration information of the maximum transmitting power includes: configuration information of a terminal maximum transmitting power PCMAX of the terminal device, and configuration information of a first panel maximum transmitting power PCMAX,P1 of the first antenna panel and a second panel maximum transmitting power PCMAX,P2 of the second antenna panel.

In an embodiment, in a case where the terminal maximum transmitting power PCMAX is greater than a sum of the first panel maximum transmitting power PCMAX,P1 and the second panel maximum transmitting power PCMAX,P2, the panel maximum transmitting power PCMAX,P of a first uplink transmission via the first antenna panel is the first panel maximum transmitting power PCMAX,P1, and the panel maximum transmitting power PCMAX,P of a second uplink transmission via the second antenna panel is the second panel maximum transmitting power PCMAX,P2.

In an embodiment, the first antenna panel is configured to perform a first uplink transmission in a first transmission occasion, the second antenna panel is configured to perform a second uplink transmission in a second transmission occasion, the first transmission occasion and the second transmission occasion have an overlapping symbol within a transmission slot,
in a case where the terminal maximum transmitting power PCMAX is less than or equal to a sum of the first panel maximum transmitting power PCMAX,P1 and the second panel maximum transmitting power PCMAX,P2, the panel maximum transmitting power PCMAX,P of the first uplink transmission via the first antenna panel in the overlapping symbol is a half of the first panel maximum transmitting power PCMAX,P1, and the panel maximum transmitting power PCMAX,P of the second uplink transmission via the second antenna panel in the overlapping symbol is a half of the second panel maximum transmitting power PCMAX,P2; or
in the case where the terminal maximum transmitting power PCMAX is less than or equal to the sum of the first panel maximum transmitting power PCMAX,P1 and the second panel maximum transmitting power PCMAX,P2, the panel maximum transmitting power PCMAX,P of the first uplink transmission via the first antenna panel in the overlapping symbol is a quotient obtained by dividing the first panel maximum transmitting power PCMAX,P1 by a first capability factor, and the panel maximum transmitting power PCMAX,P of the second uplink transmission via the second antenna panel in the overlapping symbol is a quotient obtained by dividing the second panel maximum transmitting power PCMAX,P2 by a second capability factor,
wherein the first capability factor is determined based on a transmission capability of the first antenna panel, and the second capability factor is determined based on a transmission capability of the second antenna panel.

In an embodiment, the first transmission occasion further includes a first non-overlapping symbol that does not overlap with the second transmission occasion within the transmission slot, and
in the case where the terminal maximum transmitting power PCMAX is less than or equal to the sum of the first panel maximum transmitting power PCMAX,P1 and the second panel maximum transmitting power PCMAX,P2, the panel maximum transmitting power PCMAX,P of the first uplink transmission via the first antenna panel in the first non-overlapping symbol is the first panel maximum transmitting power PCMAX,P1.

In an embodiment, the second transmission occasion further includes a second non-overlapping symbol that does not overlap with the first transmission occasion within the transmission slot, and
in the case where the terminal maximum transmitting power PCMAX is less than or equal to the sum of the first panel maximum transmitting power PCMAX,P1 and the second panel maximum transmitting power PCMAX,P2, the panel maximum transmitting power PCMAX,P of the second uplink transmission via the second antenna panel in the second non-overlapping symbol is the second panel maximum transmitting power PCMAX,P2.

FIG. 9 illustrates a structural block diagram of an uplink power control device provided by an embodiment of the present disclosure. The device may be realized as an access network device or as a part of an access network device. The device includes:
a sending module 402, configured to send configuration information of a maximum transmitting power to a terminal device, the configuration information of the maximum transmitting power being configured to determine respective panel maximum transmitting powers PCMAX,P corresponding to uplink transmissions respectively performed by the terminal device via two antenna panels in a case of scheduling simultaneous transmission via multi-panel (STxMP) by multi-downlink control information (M-DCI),
wherein the terminal device includes a plurality of antenna panels and supports simultaneous uplink transmissions via the plurality of antenna panels.

In an embodiment, the two antenna panels include a first antenna panel and a second antenna panel,
the configuration information of the maximum transmitting power is configured to determine a first panel maximum transmitting power PCMAX,P1 of the uplink transmission via the first antenna panel in the case of scheduling the STxMP by the M-DCI, and
the configuration information of the maximum transmitting power is configured to determine a second panel maximum transmitting power PCMAX,P2 of the uplink transmission via the second antenna panel in the case of scheduling the STxMP by the M-DCI.

In an embodiment, the first antenna panel is configured to perform a first uplink transmission, the second antenna panel is configured to perform a second uplink transmission, and a first transmission occasion of the first uplink transmission and a second transmission occasion of the second uplink transmission are overlapped in a time domain within a transmission slot,
the configuration information of the maximum transmitting power is configured to determine the first panel maximum transmitting power PCMAX,P1 of the first antenna panel in each symbol of the first transmission occasion, and
the configuration information of the maximum transmitting power is configured to determine the second panel maximum transmitting power PCMAX,P2 of the second antenna panel in each symbol of the second transmission occasion.

In an embodiment, the access network device includes a first transmission-reception point (TRP) and/or a second TRP, and
the sending module 402 is configured to send, via the first TRP, first DCI to the first antenna panel, the first DCI being configured to schedule the first antenna panel to perform the first uplink transmission in the first transmission occasion; and/or
the sending module 402 is configured to send, via the second TRP, second DCI to the second antenna panel, the second DCI being configured to schedule the second antenna panel to perform the second uplink transmission in the second transmission occasion.

In an embodiment, the configuration information of the maximum transmitting power includes one of:
configuration information of a terminal maximum transmitting power PCMAX of the terminal device;
configuration information of respective panel maximum transmitting powers PCMAX,P corresponding to the antenna panels of the terminal device; or
the configuration information of the terminal maximum transmitting power PCMAX of the terminal device, and the configuration information of the respective panel maximum transmitting powers PCMAX,P corresponding to the antenna panels of the terminal device.

In an embodiment, the sending module 402 is further configured to send a radio resource control (RRC) message to the terminal device, the RRC message including the configuration information of the maximum transmitting power.

In an embodiment, the configuration information of the maximum transmitting power includes the configuration information of the terminal maximum transmitting power PCMAX of the terminal device,
the respective panel maximum transmitting powers PCMAX,P corresponding to the uplink transmissions respectively performed via the two antenna panels are determined by one of:
obtaining the respective panel maximum transmitting powers PCMAX,P corresponding to the uplink transmissions respectively performed via the two antenna panels by dividing the terminal maximum transmitting power PCMAX equally; or
obtaining the respective panel maximum transmitting powers PCMAX,P corresponding to the uplink transmissions respectively performed via the two antenna panels by allocating the terminal maximum transmitting power PCMAX based on a power allocation factor; or
determining the respective panel maximum transmitting powers PCMAX,P corresponding to the uplink transmissions respectively performed via the two antenna panels based on indication information, the indication information being configured to indicate the respective panel maximum transmitting powers PCMAX,P of the two antenna panels,
wherein the power allocation factor is predefined, or is configured by the network device, or is reported by the terminal device.

In an embodiment, the two antenna panels include a first antenna panel and a second antenna panel, the first antenna panel is configured to perform a first uplink transmission in a first transmission occasion, the second antenna panel is configured to perform a second uplink transmission in a second transmission occasion, and the first transmission occasion and the second transmission occasion have an overlapping symbol within a transmission slot,
for the uplink transmission in the overlapping symbol, the respective panel maximum transmitting powers PCMAX,P corresponding to the uplink transmissions respectively performed via the two antenna panels are determined by one of:
obtaining the respective panel maximum transmitting powers PCMAX,P corresponding to the uplink transmissions respectively performed via the first antenna panel and the second antenna panel by dividing the terminal maximum transmitting power PCMAX equally; or
obtaining the respective panel maximum transmitting powers PCMAX,P corresponding to the uplink transmissions respectively performed via the first antenna panel and the second antenna panel by allocating the maximum transmitting power PCMAX based on the power allocation factor; or
determining the respective panel maximum transmitting powers PCMAX,P corresponding to the uplink transmissions respectively performed via the first antenna panel and the second antenna panel based on the indication information, the indication information being configured to indicate the respective panel maximum transmitting powers PCMAX,P of the two antenna panels,
wherein the power allocation factor is predefined, or is configured by the network device, or is reported by the terminal device.

In an embodiment, the first transmission occasion further includes a first non-overlapping symbol that does not overlap with the second transmission occasion in the transmission slot,
for the first uplink transmission in the first non-overlapping symbol, a first panel maximum transmitting power PCMAX,P1 corresponding to the first uplink transmission via the first antenna panel is determined by one of:
determining the terminal maximum transmitting power PCMAX as the first panel maximum transmitting power PCMAX,P1 corresponding to the first uplink transmission via the first antenna panel; or
obtaining the first panel maximum transmitting power PCMAX,P1 corresponding to the first uplink transmission via the first antenna panel by dividing the terminal maximum transmitting power PCMAX equally; or
obtaining the first panel maximum transmitting power PCMAX,P1 corresponding to the first uplink transmission via the first antenna panel by allocating the terminal maximum transmitting power PCMAX based on the power allocation factor; or
determining the first panel maximum transmitting power PCMAX,P1 corresponding to the first uplink transmission via the first antenna panel based on the indication information, the indication information being configured to indicate the respective panel maximum transmitting powers PCMAX,P of the two antenna panels,
wherein the power allocation factor is predefined, or is configured by the network device, or is reported by the terminal device.

In an embodiment, the second transmission occasion further includes a second non-overlapping symbol that does not overlap with the first transmission occasion in the transmission slot,
for the second uplink transmission in the second non-overlapping symbol, a second panel maximum transmitting power PCMAX,P2 corresponding to the second uplink transmission via the second antenna panel is determined by one of:
determining the terminal maximum transmitting power PCMAX as the second panel maximum transmitting power PCMAX,P2 corresponding to the second uplink transmission via the second antenna panel; or
obtaining the second panel maximum transmitting power PCMAX,P2 corresponding to the second uplink transmission via the second antenna panel by dividing the terminal maximum transmitting power PCMAX equally; or
obtaining the second panel maximum transmitting power PCMAX,P2 corresponding to the second uplink transmission via the second antenna panel by allocating the terminal maximum transmitting power PCMAX based on the power allocation factor; or
determining the second panel maximum transmitting power PCMAX,P2 corresponding to the second uplink transmission via the second antenna panel based on the indication information, the indication information being configured to indicate the respective panel maximum transmitting powers PCMAX,P of the two antenna panels,
wherein the power allocation factor is predefined, or is configured by the network device, or is reported by the terminal device.

In an embodiment, the two antenna panels include a first antenna panel and a second antenna panel,
the configuration information of the maximum transmitting power includes configuration information of a first panel maximum transmitting power PCMAX,P1 of the first antenna panel and a second panel maximum transmitting power PCMAX,P2 of the second antenna panel,
the panel maximum transmitting power PCMAX,P of a first uplink transmission via the first antenna panel is the first panel maximum transmitting power PCMAX,P1, and
the panel maximum transmitting power PCMAX,P of a second uplink transmission via the second antenna panel is the second panel maximum transmitting power PCMAX,P2.

In an embodiment, the two antenna panels include a first antenna panel and a second antenna panel, and
the configuration information of the maximum transmitting power includes: configuration information of a terminal maximum transmitting power PCMAX of the terminal device, and configuration information of a first panel maximum transmitting power PCMAX,P1 of the first antenna panel and a second panel maximum transmitting power PCMAX,P2 of the second antenna panel.

In an embodiment, in a case where the terminal maximum transmitting power PCMAX is greater than a sum of the first panel maximum transmitting power PCMAX,P1 and the second panel maximum transmitting power PCMAX,P2, the panel maximum transmitting power PCMAX,P of a first uplink transmission via the first antenna panel is the first panel maximum transmitting power PCMAX,P1, and the panel maximum transmitting power PCMAX,P of a second uplink transmission via the second antenna panel is the second panel maximum transmitting power PCMAX,P2.

In an embodiment, the first antenna panel is configured to perform a first uplink transmission in a first transmission occasion, the second antenna panel is configured to perform a second uplink transmission in a second transmission occasion, the first transmission occasion and the second transmission occasion have an overlapping symbol within a transmission slot,
in a case where the terminal maximum transmitting power PCMAX is less than or equal to a sum of the first panel maximum transmitting power PCMAX,P1 and the second panel maximum transmitting power PCMAX,P2, the panel maximum transmitting power PCMAX,P of the first uplink transmission via the first antenna panel in the overlapping symbol is a half of the first panel maximum transmitting power PCMAX,P1, and the panel maximum transmitting power PCMAX,P of the second uplink transmission via the second antenna panel in the overlapping symbol is a half of the second panel maximum transmitting power PCMAX,P2; or
in the case where the terminal maximum transmitting power PCMAX is less than or equal to the sum of the first panel maximum transmitting power PCMAX,P1 and the second panel maximum transmitting power PCMAX,P2, the panel maximum transmitting power PCMAX,P of the first uplink transmission via the first antenna panel in the overlapping symbol is a quotient obtained by dividing the first panel maximum transmitting power PCMAX,P1 by a first capability factor, and the panel maximum transmitting power PCMAX,P of the second uplink transmission via the second antenna panel in the overlapping symbol is a quotient obtained by dividing the second panel maximum transmitting power PCMAX,P2 by a second capability factor,
wherein the first capability factor is determined based on a transmission capability of the first antenna panel, and the second capability factor is determined based on a transmission capability of the second antenna panel.

In an embodiment, the first transmission occasion further includes a first non-overlapping symbol that does not overlap with the second transmission occasion within the transmission slot, and
in the case where the terminal maximum transmitting power PCMAX is less than or equal to the sum of the first panel maximum transmitting power PCMAX,P1 and the second panel maximum transmitting power PCMAX,P2, the panel maximum transmitting power PCMAX,P of the first uplink transmission via the first antenna panel in the first non-overlapping symbol is the first panel maximum transmitting power PCMAX,P1.

In an embodiment, the second transmission occasion further includes a second non-overlapping symbol that does not overlap with the first transmission occasion within the transmission slot, and
in the case where the terminal maximum transmitting power PCMAX is less than or equal to the sum of the first panel maximum transmitting power PCMAX,P1 and the second panel maximum transmitting power PCMAX,P2, the panel maximum transmitting power PCMAX,P of the second uplink transmission via the second antenna panel in the second non-overlapping symbol is the second panel maximum transmitting power PCMAX,P2.

FIG. 10 illustrates a schematic structure diagram of a communication device (a terminal device or an access network device) according to an embodiment of the present disclosure, and the communication device includes a processor 101, a receiver 102, a transmitter 103, a memory 104, and a bus 105.

The processor 101 includes one or more processing cores, and the processor 101 performs various functional applications and information processing by running software programs and modules.

The receiver 102 and the transmitter 103 may be implemented as one communication component, which may be a communication chip.

The memory 104 is connected to the processor 101 via the bus 105.

The memory 104 may be used to store at least one instruction, and the processor 101 is used to execute the at least one instruction to implement the various steps in the method embodiment described above.

In addition, the memory 104 may be implemented by any type of volatile or non-volatile storage devices or a combination thereof, and the volatile or non-volatile storage device includes, but is not limited to: a magnetic or optical disc, an electrically erasable programmable read-only memory (EEPROM), an erasable programmable read-only memory (EPROM), a static random access memory (SRAM), a read-only memory (ROM), a magnetic memory, a flash memory, and a programmable read-only memory (PROM).

When the communication device is implemented as a terminal device, the processor and the transceiver in the communication device involved in the embodiment of the present disclosure may perform the steps in any of the methods shown above which are performed by the terminal device, which are not repeated herein.

In a possible implementation, when the communication device is implemented as a terminal device,
the transceiver is configured to receive configuration information of a maximum transmitting power sent by an access network device, the configuration information of the maximum transmitting power being configured to determine respective panel maximum transmitting powers PCMAX,P corresponding to uplink transmissions respectively performed by the terminal device via two antenna panels in a case of scheduling simultaneous transmission via multi-panel (STxMP) by multi-downlink control information (M-DCI),
wherein the terminal device includes a plurality of antenna panels and supports simultaneous uplink transmissions via the plurality of antenna panels.

When the communication device is implemented as a network device, the processor and the transceiver in the communication device involved in the embodiment of the present disclosure may perform the steps in any of the methods shown above which are performed by the network device, which are not repeated herein.

In a possible implementation, when the communication device is implemented as a network device,
the transceiver is configured to send configuration information of a maximum transmitting power to a terminal device, the configuration information of the maximum transmitting power being configured to determine respective panel maximum transmitting powers PCMAX,P corresponding to uplink transmissions respectively performed by the terminal device via two antenna panels in a case of scheduling simultaneous transmission via multi-panel (STxMP) by multi-downlink control information (M-DCI),
wherein the terminal device includes a plurality of antenna panels and supports simultaneous uplink transmissions via the plurality of antenna panels.

In an embodiment, there is also provided a computer-readable storage medium having stored therein at least one instruction, at least one program, a code set or an instruction set that, when being loaded and executed by a processor, implements the uplink power control method performed by a communication device provided by the respective method embodiment above.

In an embodiment, there is also provided a chip including a programmable logic circuit and/or a program instruction, and the chip, when running on a computer device, implements the uplink power control method according to the above aspect.

In an embodiment, there is also provided a computer program product that, when running on a processor of a computer device, causes the computer device to implement the uplink power control method according to the above aspect.

A person skilled in the art may understand that all or some of the steps for implementing the above embodiment may be accomplished by hardware, or may be accomplished by a program that instructs the relevant hardware, the program may be stored in a computer-readable storage medium, and the storage medium mentioned above may be a read-only memory, a magnetic disc, or a compact disc, and the like.

The above mentioned are only embodiments of the present disclosure, and are not intended to limit the present disclosure, and any modifications, equivalent replacements, improvements, or the like made within the spirit and principle of the present disclosure shall be included in the protection scope of the present disclosure.

1. An uplink power control method, performed by a terminal device, comprising:
receiving configuration information of a maximum transmitting power sent by a radio access network, the configuration information of the maximum transmitting power being configured to determine respective panel maximum transmitting powers P_{CMAX,P} corresponding to uplink transmissions respectively performed by the terminal device via two antenna panels when scheduling simultaneous transmission via multi-panel (STxMP) by multi-downlink control information (M-DCI),
wherein the terminal device comprises a plurality of antenna panels and supports simultaneous uplink transmissions via the plurality of antenna panels.

2. The uplink power control method according to claim 1, wherein the two antenna panels comprise a first antenna panel and a second antenna panel,
the configuration information of the maximum transmitting power is configured to determine a first panel maximum transmitting power P_{CMAX,P1} of the uplink transmission via the first antenna panel when scheduling the STxMP by the M-DCI, and
the configuration information of the maximum transmitting power is configured to determine a second panel maximum transmitting power P_{CMAX,P2} of the uplink transmission via the second antenna panel when scheduling the STxMP by the M-DCI.

3. The uplink power control method according to claim 2, wherein the first antenna panel is configured to perform a first uplink transmission, the second antenna panel is configured to perform a second uplink transmission, and a first transmission occasion of the first uplink transmission and a second transmission occasion of the second uplink transmission are overlapped in a time domain within a transmission slot,
the configuration information of the maximum transmitting power is configured to determine the first panel maximum transmitting power P_{CMAX,P1} of the first antenna panel in each symbol of the first transmission occasion, and
the configuration information of the maximum transmitting power is configured to determine the second panel maximum transmitting power P_{CMAX,P2} of the second antenna panel in each symbol of the second transmission occasion.

4. The uplink power control method according to claim 3, further comprising:
receiving, via the first antenna panel, first DCI sent by a first transmission-reception point (TRP), the first DCI being configured to schedule the first antenna panel to perform the first uplink transmission in the first transmission occasion; and
receiving, via the second antenna panel, second DCI sent by a second TRP, the second DCI being configured to schedule the second antenna panel to perform the second uplink transmission in the second transmission occasion.

5. The uplink power control method according to claim 1, wherein the configuration information of the maximum transmitting power comprises one of:
configuration information of a terminal maximum transmitting power P_{CMAX} of the terminal device;
configuration information of respective panel maximum transmitting powers P_{CMAX,P} corresponding to the antenna panels of the terminal device; or
the configuration information of the terminal maximum transmitting power P_{CMAX} of the terminal device, and the configuration information of the respective panel maximum transmitting powers P_{CMAX,P} corresponding to the antenna panels of the terminal device.

6. The uplink power control method according to claim 5, wherein receiving the configuration information of the maximum transmitting power sent by the radio access network comprises:
receiving a radio resource control (RRC) message sent by the radio access network, the RRC message comprising the configuration information of the maximum transmitting power.

7. The uplink power control method according to claim 5, wherein the configuration information of the maximum transmitting power comprises the configuration information of the terminal maximum transmitting power P_{CMAX} of the terminal device,
the respective panel maximum transmitting powers P_{CMAX,P} corresponding to the uplink transmissions respectively performed via the two antenna panels are determined by:
obtaining the respective panel maximum transmitting powers P_{CMAX,P} corresponding to the uplink transmissions respectively performed via the two antenna panels by dividing the terminal maximum transmitting power P_{CMAX} equally;
obtaining the respective panel maximum transmitting powers P_{CMAX,P} corresponding to the uplink transmissions respectively performed via the two antenna panels by allocating the terminal maximum transmitting power P_{CMAX} based on a power allocation factor; or
determining the respective panel maximum transmitting powers P_{CMAX,P} corresponding to the uplink transmissions respectively performed via the two antenna panels based on indication information, the indication information being configured to indicate the respective panel maximum transmitting powers P_{CMAX,P} of the two antenna panels,
wherein the power allocation factor is predefined, or is configured by the network device, or is reported by the terminal device.

8. The uplink power control method according to claim 7, wherein the two antenna panels comprise a first antenna panel and a second antenna panel, the first antenna panel is configured to perform a first uplink transmission in a first transmission occasion, the second antenna panel is configured to perform a second uplink transmission in a second transmission occasion, and the first transmission occasion and the second transmission occasion have an overlapping symbol within a transmission slot,
for the uplink transmission in the overlapping symbol, the respective panel maximum transmitting powers P_{CMAX,P} corresponding to the uplink transmissions respectively performed via the two antenna panels are determined by:
obtaining the respective panel maximum transmitting powers P_{CMAX,P} corresponding to the uplink transmissions respectively performed via the first antenna panel and the second antenna panel by dividing the terminal maximum transmitting power P_{CMAX} equally;
obtaining the respective panel maximum transmitting powers P_{CMAX,P} corresponding to the uplink transmissions respectively performed via the first antenna panel and the second antenna panel by allocating the maximum transmitting power P_{CMAX} based on the power allocation factor; or
determining the respective panel maximum transmitting powers P_{CMAX,P} corresponding to the uplink transmissions respectively performed via the first antenna panel and the second antenna panel based on the indication information, the indication information being configured to indicate the respective panel maximum transmitting powers P_{CMAX,P} of the two antenna panels,
wherein the power allocation factor is predefined, or is configured by the network device, or is reported by the terminal device.

9. The uplink power control method according to claim 8, wherein the first transmission occasion further comprises a first non-overlapping symbol that does not overlap with the second transmission occasion in the transmission slot,
for the first uplink transmission in the first non-overlapping symbol, a first panel maximum transmitting power P_{CMAX,P1} corresponding to the first uplink transmission via the first antenna panel is determined by:
determining the terminal maximum transmitting power P_{CMAX} as the first panel maximum transmitting power P_{CMAX,P1} corresponding to the first uplink transmission via the first antenna panel;
obtaining the first panel maximum transmitting power P_{CMAX,P1} corresponding to the first uplink transmission via the first antenna panel by dividing the terminal maximum transmitting power P_{CMAX} equally;
obtaining the first panel maximum transmitting power P_{CMAX,P1} corresponding to the first uplink transmission via the first antenna panel by allocating the terminal maximum transmitting power P_{CMAX} based on the power allocation factor; or
determining the first panel maximum transmitting power P_{CMAX,P1} corresponding to the first uplink transmission via the first antenna panel based on the indication information, the indication information being configured to indicate the respective panel maximum transmitting powers P_{CMAX,P} of the two antenna panels,
wherein the power allocation factor is predefined, or is configured by the network device, or is reported by the terminal device.

10. The uplink power control method according to claim 8, wherein the second transmission occasion further comprises a second non-overlapping symbol that does not overlap with the first transmission occasion in the transmission slot,
for the second uplink transmission in the second non-overlapping symbol, a second panel maximum transmitting power P_{CMAX,P2} corresponding to the second uplink transmission via the second antenna panel is determined by:
determining the terminal maximum transmitting power P_{CMAX} as the second panel maximum transmitting power P_{CMAX,P2} corresponding to the second uplink transmission via the second antenna panel;
obtaining the second panel maximum transmitting power P_{CMAX,P2} corresponding to the second uplink transmission via the second antenna panel by dividing the terminal maximum transmitting power P_{CMAX} equally;
obtaining the second panel maximum transmitting power P_{CMAX,P2} corresponding to the second uplink transmission via the second antenna panel by allocating the terminal maximum transmitting power P_{CMAX} based on the power allocation factor; or
determining the second panel maximum transmitting power P_{CMAX,P2} corresponding to the second uplink transmission via the second antenna panel based on the indication information, the indication information being configured to indicate the respective panel maximum transmitting powers P_{CMAX,P} of the two antenna panels,
wherein the power allocation factor is predefined, or is configured by the network device, or is reported by the terminal device.

11. The uplink power control method according to claim 5-er 6, wherein the two antenna panels comprise a first antenna panel and a second antenna panel,
the configuration information of the maximum transmitting power comprises configuration information of a first panel maximum transmitting power P_{CMAX,P1} of the first antenna panel and a second panel maximum transmitting power P_{CMAX,P2} of the second antenna panel,
the panel maximum transmitting power P_{CMAX,P} of a first uplink transmission via the first antenna panel is the first panel maximum transmitting power P_{CMAX,P1}, and
the panel maximum transmitting power P_{CMAX,P} of a second uplink transmission via the second antenna panel is the second panel maximum transmitting power P_{CMAX,P2}.

12. The uplink power control method according to claim 5, wherein the two antenna panels comprise a first antenna panel and a second antenna panel, and
the configuration information of the maximum transmitting power comprises: configuration information of a terminal maximum transmitting power P_{CMAX} of the terminal device, and configuration information of a first panel maximum transmitting power P_{CMAX,P1} of the first antenna panel and a second panel maximum transmitting power P_{CMAX,P2} of the second antenna panel.

13. The uplink power control method according to claim 12, wherein
the terminal maximum transmitting power P_{CMAX} is greater than a sum of the first panel maximum transmitting power P_{CMAX,P1} and the second panel maximum transmitting power P_{CMAX,P2}, the panel maximum transmitting power P_{CMAX,P} of a first uplink transmission via the first antenna panel is the first panel maximum transmitting power P_{CMAX,P1}, and the panel maximum transmitting power P_{CMAX,P} of a second uplink transmission via the second antenna panel is the second panel maximum transmitting power P_{CMAX,P2}.

14. The uplink power control method according to claim 12, wherein the first antenna panel is configured to perform a first uplink transmission in a first transmission occasion, the second antenna panel is configured to perform a second uplink transmission in a second transmission occasion, the first transmission occasion and the second transmission occasion have an overlapping symbol within a transmission slot,
the terminal maximum transmitting power P_{CMAX} is less than or equal to a sum of the first panel maximum transmitting power P_{CMAX,P1} and the second panel maximum transmitting power P_{CMAX,P2},
the panel maximum transmitting power P_{CMAX,P} of the first uplink transmission via the first antenna panel in the overlapping symbol is a half of the first panel maximum transmitting power P_{CMAX,P1}, and the panel maximum transmitting power P_{CMAX,P} of the second uplink transmission via the second antenna panel in the overlapping symbol is a half of the second panel maximum transmitting power P_{CMAX,P2}; or
the panel maximum transmitting power P_{CMAX,P} of the first uplink transmission via the first antenna panel in the overlapping symbol is a quotient obtained by dividing the first panel maximum transmitting power P_{CMAX,P1} by a first capability factor, and the panel maximum transmitting power P_{CMAX,P} of the second uplink transmission via the second antenna panel in the overlapping symbol is a quotient obtained by dividing the second panel maximum transmitting power P_{CMAX}, P2 by a second capability factor,
wherein the first capability factor is determined based on a transmission capability of the first antenna panel, and the second capability factor is determined based on a transmission capability of the second antenna panel.

15. The uplink power control method according to claim 14, wherein the first transmission occasion further comprises a first non-overlapping symbol that does not overlap with the second transmission occasion within the transmission slot, and
the panel maximum transmitting power P_{CMAX,P} of the first uplink transmission via the first antenna panel in the first non-overlapping symbol is the first panel maximum transmitting power P_{CMAX,P1}.

16. The uplink power control method according to claim 14, wherein the second transmission occasion further comprises a second non-overlapping symbol that does not overlap with the first transmission occasion within the transmission slot, and
the panel maximum transmitting power P_{CMAX,P} of the second uplink transmission via the second antenna panel in the second non-overlapping symbol is the second panel maximum transmitting power P_{CMAX,P2}.

17. An uplink power control method, performed by a radio access network, comprising:
sending configuration information of a maximum transmitting power to a terminal device, the configuration information of the maximum transmitting power being configured to determine respective panel maximum transmitting powers P_{CMAX,P} corresponding to uplink transmissions respectively performed by the terminal device via two antenna panels when scheduling simultaneous transmission via multi-panel (STxMP) by multi-downlink control information (M-DCI),
wherein the terminal device comprises a plurality of antenna panels and supports simultaneous uplink transmissions via the plurality of antenna panels.

18-34. (canceled)

35. A terminal device, comprising a processor and a memory having a computer program stored thereon that when being executed by the processor, causes the terminal device to:
receive configuration information of a maximum transmitting power sent by a radio access network, the configuration information of the maximum transmitting power being configured to determine respective panel maximum transmitting powers P_{CMAX,P} corresponding to uplink transmissions respectively performed by the terminal device via two antenna panels when scheduling simultaneous transmission via multi-panel (STxMP) by multi-downlink control information (M-DCI),
wherein the terminal device comprises a plurality of antenna panels and supports simultaneous uplink transmissions via the plurality of antenna panels.

36. A network device, comprising a processor and a memory having a computer program stored thereon that, when being executed by the processor, causes the network device to perform the uplink power control method according to claim 17.

37. A non-volatile computer-readable storage medium having executable instructions stored thereon, wherein the executable instructions are loaded and executed by a processor to implement the uplink power control method according to claim 1.

38. (canceled)
